(19) United States
(12) Patent Application Publication
(10) Pub. No.: US 2026/0251667 A1
(43) Pub. Date: Aug. 27, 2026

(54) AUTOMATIC ANALYZER AND TIMING SETTING METHOD

(71) Applicant: Hitachi High-Tech Corporation, Tokyo (JP)

(72) Inventors: Fujio ONISHI, Tokyo (JP); Yoichiro SUZUKI, Tokyo (JP); Gorou YOSHIDA, Tokyo (JP); Kosuke SUZUKI, Tokyo (JP); Yuki SUGAWARA, Tokyo (JP)

(21) Appl. No.: 19/160,091

(22) PCT Filed: Apr. 23, 2024
(86) PCT No.: PCT/JP2024/015956

§ 371 Date: Aug. 27, 2025

(30) Foreign Application Priority Data
May 16, 2023 (JP) 2023-080740

(51) Int. Cl. G01N 35/00; G01N 35/04

(52) U.S. Cl. CPC G01N 35/00584; G01N 2035/0097; G01N 2035/0444

(57) ABSTRACT

In order to provide an automatic analyzer capable of improving the measurement stability, the following configuration is adopted. A control unit acquires a photometric waveform for each of a plurality of reaction cells held on a reaction disk from a photometry signal based on a photometry trigger signal, and sets a photometric value calculation period based on a time domain, the photometry signal being obtained by executing photometry of the plurality of reaction cells in an empty state or in a state where blank water is accommodated, the photometry trigger signal representing that each of the plurality of reaction cells crosses an optical axis of a light source, and the time domain representing a flat waveform obtained regarding the photometric waveform for each of the plurality of reaction cells.

### TECHNICAL FIELD

The present invention relates to an automatic analyzer and a timing setting method thereof.

### BACKGROUND ART

An automatic analyzer executes quantitative analysis of a material to be tested by mixing the material to be tested in a sample such as blood, urine, or body fluid and a reagent corresponding to the material to be tested with each other, irradiating the formed reactant with light, and measuring an absorbance, a turbidity, a reflectance, or the like. A plurality of reaction cells where the sample and the reagent are mixed are measured within a short period of time by placing the reaction cells on a disk-shaped reaction disk and rotating the reaction disk. Therefore, a waveform portion including information regarding the reaction liquid obtained by mixing the sample and the reagent needs to be extracted from a continuous waveform obtained by measuring the plurality of reaction cells.

Examples of a technique of optimizing a photometry timing include PTLs 1 to 3. PTL 1 discloses a technique where, in a state where a reaction cell is filled with water, photometry is repeatedly executed while changing a photometry timing at a small time interval, and a photometry timing at which a variation width of photometric values in all of the reaction cells is small is determined as an optimum photometry timing. PTL 2 discloses a technique of calculating an optimum photometry available region for each reaction container. Specifically, in the technique disclosed in PTL 2, in a waveform, a point that is ½ of a time difference of a timing at which light passes through a side surface of a reaction container or a time difference of a timing at which light passes through a portion that is a cavity between reaction containers is set as a central value of the reaction containers, and the optimum photometry available region for each reaction container is determined based on the central value. Further, PTL 3 discloses a technique of correcting a photometry start timing or a photometry end timing for rotation unevenness of a reaction disk.

### CITATION LIST

### Patent Literature

PTL 1: JPH6-167505A
PTL 2: JP2009-162719A
PTL 3: JP2009-162720A

### SUMMARY OF INVENTION

### Technical Problem

In PTL 1, photometry is repeatedly executed on the reaction cells filled with water while changing the photometry timing at the small time interval. Therefore, in order to determine the optimum photometry timing, the measurement needs to be executed multiple times, which is troublesome.

On the other hand, in PTL 2, for example, by executing photometry in an empty reaction container state, a photometry timing can be determined based on the photometric waveform. Specifically, for example, the timing at which light passes through the side surface of the reaction container is specified as a change point of the waveform. However, there is a variation in the shape of the waveform depending on each reaction container due to a variation between the shapes of the individual reaction containers, a variation between attachment positions to the reaction disk, or the like. Therefore, the slope of the waveform transitioning from the change point to a flat portion suitable for the photometry of the e: reaction liquid largely varies depending on each reaction container. There may be a waveform transitioning from the change point to a flat portion with a steep slope, or may be a waveform transitioning from the change point to a flat portion with a gentle slope. Therefore, in the method disclosed in PTL 2 in which the photometry available region is determined based on the central value of the reaction containers, the photometry available region needs to be determined such that the photometry available region is fitted into the flat portion even for the waveform with a gentle slope, and it is difficult to extend the length of the photometry available region.

### Solution to Problem

According to one embodiment of the present invention, there is provided an automatic analyzer including: a reaction disk where a plurality of reaction cells are held on a circumference and configured to execute a rotation operation; a light source configured to emit light; a spectroscopic analyzer configured to detect transmitted light that transmits through a reaction cell crossing an optical axis of the light source when the reaction disk executes the rotation operation; and a control unit including a photometry unit configured to extract, from a photometric waveform, a photometric waveform of a photometric value calculation period used for calculating a light intensity value regarding a liquid accommodated in the reaction cell, the photometric waveform being obtained by sampling a photometry signal that reflects a light intensity value of the transmitted light output from the spectroscopic analyzer, in which the control unit acquires a photometric waveform for each of the plurality of reaction cells held on the reaction disk from a photometry signal based on a photometry trigger signal, and sets the photometric value calculation period based on a time domain representing a flat waveform, the photometry signal being obtained by executing photometry of the plurality of reaction cells in an empty state or in a state where blank water is accommodated, the photometry trigger signal representing that each Of the plurality of reaction cells crosses the optical axis of the light source, and the time domain being obtained regarding the photometric waveform for each of the plurality of reaction cells.

### Advantageous Effects of Invention

According to the present invention, a photometric value of a reaction liquid can be calculated using a photometric value in a time domain representing a flat waveform of reaction cell acquired before allowing an automatic analyzer to execute a specimen test, and the measurement stability of the device can be improved. Other objects and new characteristics will be clarified with reference to description of the present specification and the accompanying drawings.

### BRIEF DESCRIPTION OF DRAWINGS

FIG. 1 is a diagram illustrating an overall configuration of an automatic analyzer.

FIG. 2 is a schematic diagram illustrating the summary of a position detection unit.

FIG. 3A is a diagram illustrating a photometry method of a reaction liquid in a reaction cell.

FIG. 3B is a diagram illustrating the photometry method of the reaction liquid in the reaction cell.

FIG. 4 is a diagram illustrating photometric waveforms that are arranged for respective reaction cells with reference to rising of a photometry trigger signal T.

FIG. 5 is a flow of calculating a correction time t_{cal}_st.

FIG. 6 is a diagram illustrating a first example of calculating the correction time t_{cal}_st.

FIG. 7 is a diagram illustrating an example of extracting a photometric waveform of a photometric value calculation period t_{cal} for each reaction cell.

FIG. 8 is a diagram illustrating a modification example of a second example of calculating the correction time t_{cal}_st.

FIG. 9 is a diagram illustrating a third example of calculating the correction time t_{cal}_st.

FIG. 10A is an example of a correction time storage memory in the third example.

FIG. 10B is an example of a photometric value calculation period storage memory in the third example.

FIG. 11 is a diagram illustrating abnormal waveform determination such as foreign matter, a bubble, or a scratch.

FIG. 12 is a diagram illustrating estimation of a foreign matter width.

FIG. 13 is a diagram illustrating self-diagnosis of a light flux width.

FIG. 14 is a diagram illustrating detection of a stirring failure or an insufficient liquid amount in a reaction liquid.

### DESCRIPTION OF EMBODIMENTS

Hereinafter, embodiments will be described with reference to the drawings.

### First Embodiment

A configuration and an operation of an automatic analyzer will be described by using, as an example, an automatic analyzer 100 that executes colorimetric analysis using a biochemical reaction.

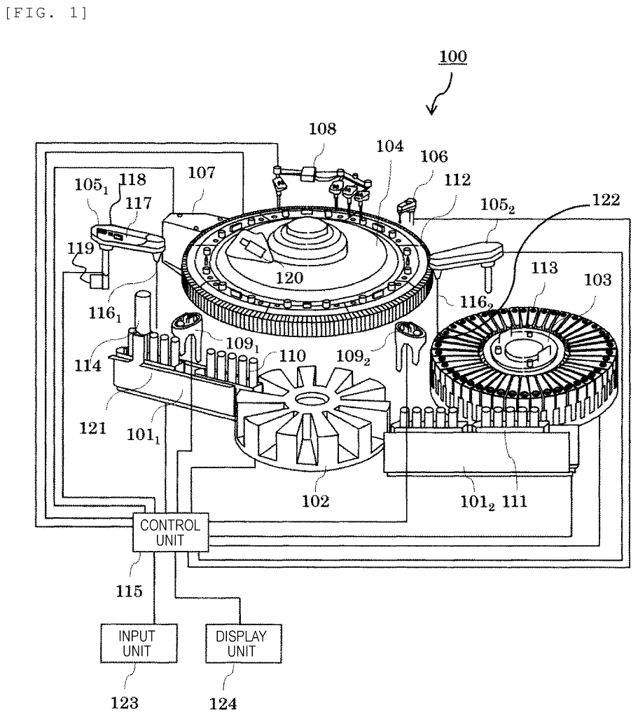

FIG. 1 illustrates an overall configuration of the automatic analyzer 100. Here, an automatic analyzer that executes colorimetric analysis using a biochemical reaction will be described as an example. The automatic analyzer 100 is configured to include a transport line 101, a rotor 102, a reagent disk 103, a reaction disk 104, an aliquoting mechanism 105, a stirring mechanism 106, a spectroscopic analyzer 107, a reaction cell cleaning mechanism 108, a nozzle cleaning mechanism 109, a control unit 115, an input unit 123, and a display unit 124. When a plurality of certain mechanisms are distinguished from each other for description, suffixes are added to distinguish between the mechanisms.

A transport line 101₁ transports a specimen rack 111 that holds specimen containers 110 containing a specimen to a specimen aliquoting position 121. An aliquoting mechanism (specimen aliquoting mechanism) 105₁ aliquots the specimen from the specimen container 110 into a reaction cell (reaction container) 112 on the reaction disk 104 at the specimen aliquoting position 121. The transport line 101₁ is further connected to the rotor 102. By placing the specimen rack 111 on the rotor 102 and rotating the rotor 102, the specimen rack 111 is transported to another transport line 101₂.

The reagent disk 103 holds reagent containers 113 containing a reagent and rotates and transports each of the reagent containers 113 to a position where an aliquoting mechanism (reagent aliquoting mechanism) 105₂ can execute an aliquoting operation. The aliquoting mechanism 105₂ aliquots the reagent from the reagent container 113 to the reaction cell 112 on the reaction disk 104 at a reagent aliquoting position 122. A necessary amount Of the reagent for the colorimetric analysis is aliquoted into the reaction cell 112 and reacts with a component as an analysis target in the specimen.

The reaction disk 104 holds the reaction cells 112 on the circumference thereof. In the vicinity of the reaction disk 104, the spectroscopic analyzer 107 that executes colorimetric analysis, the stirring £ mechanism 106, the reaction cell cleaning mechanism 108, and the like are disposed, and the reaction cells 112 that are targets of the operations of the units are rotated and transported to operation positions as positions where the units operate, respectively. The reaction cell 112 is kept warm by constant-temperature medium such as water. As a result, in a reaction liquid that is a mixture of the specimen and the reagent, a chemical reaction of the component in the specimen and the reagent is promoted.

The aliquoting mechanism 105₁ aspirates the specimen for the colorimetric analysis from the specimen container 110 and discharges the specimen to the reaction cell 112. The aliquoting mechanism 105₂ aspirates the reagent corresponding to the analysis target from the reagent container 113, and discharges the reagent to the reaction cell 112. Each of the aliquoting mechanisms 105 (105₁ to 105₂) includes an arm 118, a nozzle 116, and a motor 119 for aliquoting mechanism. The arm 118 holds the nozzle 116 and a liquid level sensor 117. The nozzle 116 is connected to the liquid level sensor 117. The liquid level sensor 117 detects whether or not liquid is present using a change in capacitance. In the vicinity of the position where the aliquoting mechanism 105 executes the aliquoting operation, a shield portion 114 is provided. The motor 119 for aliquoting mechanism moves the aliquoting mechanism 105 in an up-down direction or in a rotation direction.

The stirring mechanism 106 stirs the reaction liquid in the reaction cell 112 to promote the reaction of the analysis target component in the specimen discharged from the specimen container 110 into the reaction cell 112 and the reagent discharged from the reagent container 113 into the reaction cell 112.

A light source 120 emits output light to the reaction liquid that is stirred by the stirring mechanism 106 such that the chemical reaction occurs. As the light source 120, for example, a LED (Light Emitting Diode) is used. The spectroscopic analyzer 107 disperses transmitted light that transmits through the reaction liquid in the reaction cell 112, and measures a light intensity of the dispersed transmitted light. The colorimetric analysis is executed by absorbance measurement based on the light intensity of the dispersed transmitted light.

The reaction cell cleaning mechanism 108 aspirates the reaction liquid from the reaction cell 112 after completion of the colorimetric analysis, and discharges a cleaner or the like into the reaction cell 112 to clean the reaction cell 112.

The nozzle cleaning mechanisms 109 (109₁ and 109₂) clean tips of the nozzles 116 of the aliquoting mechanisms 105 (105₁ and 105₂) that have aliquoted the specimen or the reagent, respectively. As a result, residues attached to the nozzle 116 are removed and do not affect the next analysis target.

The control unit 115 is configured with a processor, a memory, and the like and controls each of the mechanisms. The input unit 123 is configured with a keyboard, a mouse, a touch panel, and the like and inputs an instruction from a user to the control unit 115. The display unit 124 is configured with a LCD (Liquid Crystal Display) or the like, and displays an operation screen or the like.

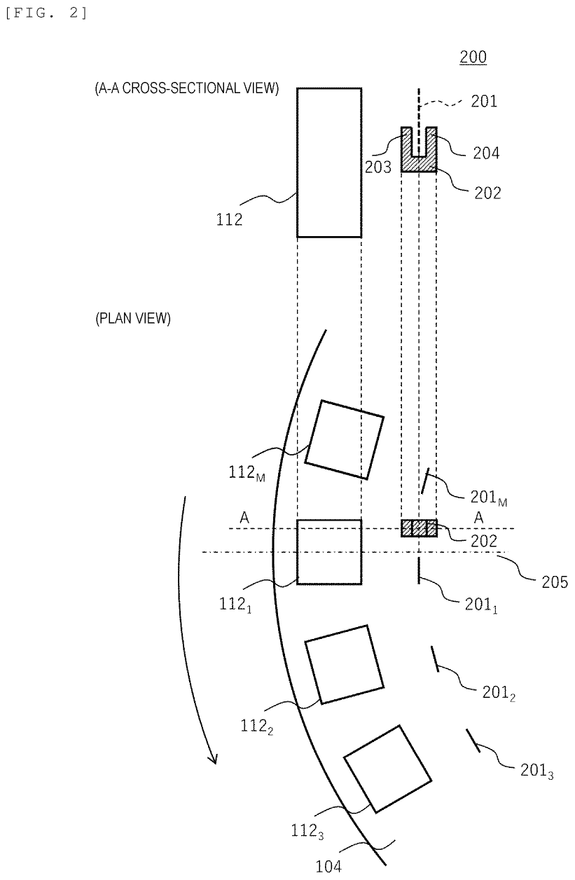

FIG. 2 is a schematic diagram illustrating the summary of a position detection unit provided in the reaction disk 104. A position detection unit 200 includes, for example, a detection plate 201 and a detection plate detector 202. As illustrated in FIG. 2, the detection plates 201 of the same number as that of the reaction cells 112 are provided in the reaction disk 104 to satisfy an one-to-one relationship. In addition, the detection plate detector 202 is provided at a position where a detection plate 2011 crossing an optical axis 205 of the light source 120 can be detected. For example, the detection plate detector 202 includes a light emitting unit 203 and a photodetection unit 204, and detects passage of the detection plate 201 when the detection plate 201 passes between the light emitting unit 203 and the photodetection unit 204 to block light from the light emitting unit 203. The position detection unit 200 outputs a detection signal obtained when the detection plate detector 202 detects the passage of the detection plate 201, as a photometry trigger signal representing the passage of the reaction cell 112 between the light source 120 and the spectroscopic analyzer 107.

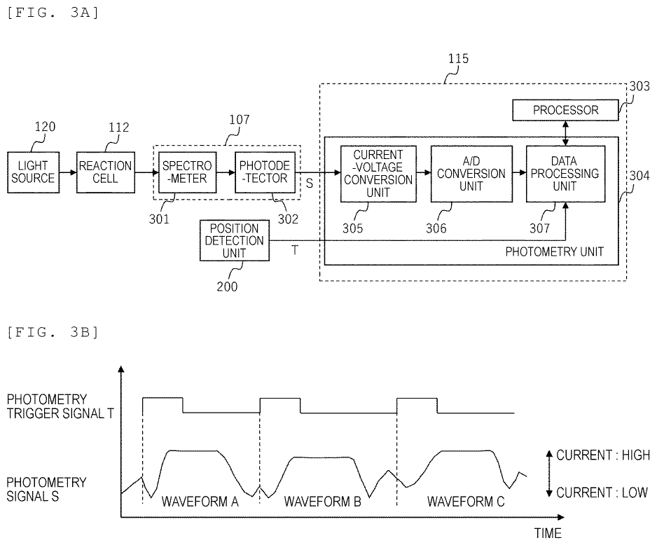

A photometry method of the reaction liquid in the reaction cell 112 in the automatic analyzer 100 will be described using FIGS. 3A and 3B. Light is emitted from the light source 120 to the reaction cell 112 accommodating the reaction liquid, and transmitted light transmitting through the reaction cell 112 is incident on the spectroscopic analyzer 107. The spectroscopic analyzer 107 includes a spectrometer 301 and a photodetector 302. The spectrometer 301 separates the transmitted light into a plurality of wavelengths, and the photodetector 302 detects a light intensity value of the transmitted light for each of the separated wavelengths. Specifically, the photodetector 302 outputs a photometry signal S having current value proportional to the light intensity value of the transmitted light, and the photometry signal S is input to a photometry unit 304 of the control unit 115.

The photometry unit 304 includes a current-voltage conversion unit 305, an A/D conversion unit 306, and a data processing unit 307. The current-voltage conversion unit 305 converts the photometry signal S into a voltage value. The A/D conversion unit 306 samples a photometry voltage value signal that is an analog signal at a predetermined sampling period and converts the sampled signal into a digital signal. The data processing unit 307 generates a photometric waveform representing a change in the light intensity of the transmitted light transmitting through the reaction cell 112 regarding the photometry voltage signal converted into the digital signal. In addition, a photometry trigger signal T is input from the position detection unit 200 to the data processing unit 307.

FIG. 3B schematically illustrates the photometry signal S and the photometry trigger signal T input to the photometry unit 304. It is assumed that photometry of the reaction cell 112 is executed in an empty state or in a state where blank water is filled. The photometry is executed in a state where the reaction disk 104 is rotated. Therefore, the photometric waveform is a continuous waveform that is the same as that of the photometry signal S of FIG. 3B. In the photometric waveform corresponding to one reaction cell 112, the light intensity value is significantly attenuated when the optical axis 205 of the light source 120 passes through a side wall of the reaction cell 112. Accordingly, a photometric waveform in a period interposed between the attenuated portions includes information regarding the transmitted light of the reaction liquid accommodated in the reaction cell 112. Therefore, the data processing unit 307 extracts a photometric waveform of a predetermined photometric value calculation period t_{cal}. The photometric value calculation period t_{cal} is a period used for calculating the light intensity value regarding the reaction liquid accommodated in the reaction cell 112. The data processing unit 307 calculates the light intensity value of the transmitted light of the reaction liquid based on the extracted photometric waveform. The calculated light intensity value is transmitted to a processor 303 of the control unit 115, and the analysis of the reaction liquid is executed.

Although not illustrated in FIG. 3A, the photometry signal S of the transmitted light for each of the separated wavelengths is input from the photodetector 302 to the photometry unit 304. The processes to be executed by the current-voltage conversion unit 305, the A/D conversion unit 306, and the data processing unit 307 described above regarding the photometric waveform for each of the separated wavelengths are executed in parallel.

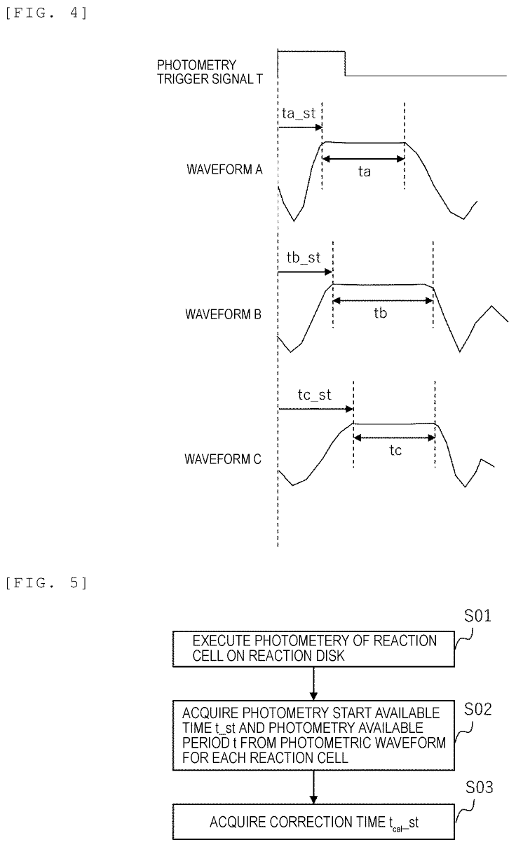

FIG. 4 illustrates the photometric waveforms corresponding to the photometry signal S illustrated in FIG. 3B, arranged for the respective reaction cells with reference to rising of the photometry trigger signal T. In the photometric waveform for each of the reaction cells, a time period that is a flat waveform where a difference between the values at adjacent sampling positions is a certain value or less is assumed as a photometry available period t, and a period from the rising of the photometry trigger signal T to the start of the photometry available period t is assumed as a photometry start available time t_st. When the photometry available period t is acquired, it is desirable to acquire the photometry available period t after removing a change caused by noise or the like. This way, a photometry start available time ta_st and a photometry available period ta in a waveform A (photometric waveform of a reaction cell A), a photometry start available time tb_st and a photometry available period tb in a waveform B (photometric waveform of a reaction cell B), and a photometry start available time tc_st and a photometry available period tc in a waveform C (photometric waveform of a reaction cell C) vary, respectively. The reason for the variation is a variation in the container shape, a variation in the attachment position to the reaction disk, or scattered light from an adjacent container. In the present embodiment, the photometry available period t and the photometry start available time t_st are obtained for the photometric waveform for each of the reaction cells that has a large variation, and a timing at which the extraction of the photometric waveform used for calculating the light intensity value for the reaction liquid starts from the rising of the photometry trigger signal T, that is, a start timing of the photometric value calculation period t_{cal} is determined. Hereinafter, a period of time from the rising of the photometry trigger signal I to the start timing of the photometric value calculation period t_{cal} will be referred to as a correction time t_{cal}_st.

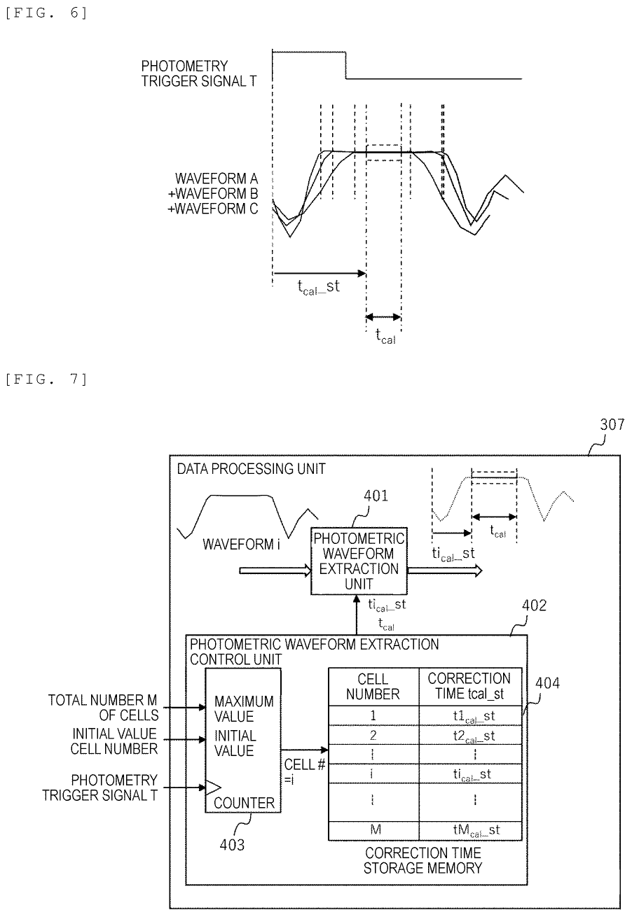

FIG. 5 illustrates a flow of calculating the correction time t_{cal}_st in the present embodiment. The photometric value calculation period t_{cal} is predetermined as a period common to the reaction cells 112 on the reaction disk 104. This flow is executed by the control unit 115.

First, photometry of the reaction cells 112 on the reaction disk 104 is executed (S01). The reaction cell 112 may be in an empty state or in a state where blank water is accommodated. In addition, this flow is executed when the replacement of the reaction cell or the like is executed, but the present invention is not limited thereto. The flow may be executed at any timing.

Next, the photometry start available time t_st and the photometry available period t illustrated in FIG. 4 are acquired from the photometric waveform for each of the reaction cells (S02). The correction time t_{cal}_st is acquired based on the photometry start available times t_st and the photometry available periods t of the reaction cells 112 on the reaction disk 104 acquired in Step S02 (S03). The acquired correction time t_{cal}_st is stored in the control unit 115, and is used for extracting the photometric waveform of the photometric value calculation period t_{cal} in the data processing unit 307. Hereinafter, a calculation example of the correction time t_{cal}_st in Step S03 will be described.

First Example of Calculating Correction Time t_{cal}_st

In a first example, the correction time t_{cal}_st common to the reaction cells 112 on the reaction disk 104 is calculated. In FIG. 6, the waveforms A to C illustrated in FIG. 4 are illustrated to overlap each other, and a relationship between the correction time t_{cal}_st and the photometric value calculation period t_{cal} is illustrated. That is, the correction time t_{cal}_st is set such that the photometric value calculation period t_{cal} is included in the photometry available periods t of the photometric waveforms corresponding to the reaction cells on the reaction disk 104. For example, assuming that the maximum value among the photometry start available times t_st of the reaction cells on the reaction disk 104 is a latest photometry start available time t_st_max, the correction time t_{cal}_st is set to satisfy the following relationship.

Correction Time t_{cal}_st>Latest Photometry Start Available Time t_st_max

In the first example, by setting the correction time t_{cal}_st common to the reaction cells 112 on the reaction disk 104, the extraction process of the photometric waveform of the photometric value calculation period t_{cal} in the data processing unit 307 can be simplified. In addition, since the correction time t_{cal}_st is acquired from the actual waveforms, the photometric value calculation period t_{cal} can be increased as long as possible. However, the possible photometric value calculation period t_{cal} is unavoidably limited to the size of the variation of the reaction cells 112. As a second example, an example of setting the correction time t_{cal}_st for each of the reaction cells 112 on the reaction disk 104 will be described.

Second Example of Calculating Correction Time t_{cal}_st

In the second example, the correction time t_{cal}_st is set for each of the reaction cells 112 on the reaction disk 104. That is, for each of the reaction cells, the correction time t_{cal}_st is set to satisfy the following relationship.

Correction Time t_{cal}_st>Photometry Start Available Time t_st As a result, the photometric value calculation period t_{cal} can be increased from the photometric waveforms corresponding to the reaction cells without being limited to the variation of the reaction cells 112 on the reaction disk 104. The increase in the photometric value calculation period t_{cal} is effective in that, for example, even when a region that is affected by a bubble is partially present during measurement of a specimen, there is a high possibility that a sufficient photometric waveform can be obtained even after excluding the region affected by a bubble, and the number of cases where remeasurement is required can be reduced.

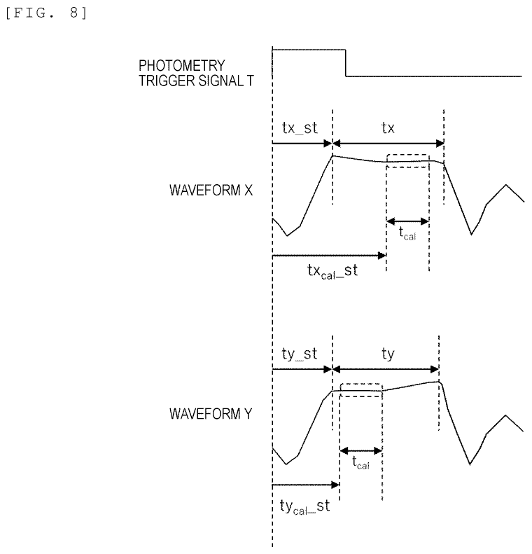

Using FIG. 7, an example of the data processing unit 307 extracts the photometric waveform of the photometric value calculation period t_{cal} for each of the reaction cells will be described. The data processing unit 307 includes a photometric waveform extraction unit 401 and a photometric waveform extraction control unit 402 as functional units for extracting the photometric waveform. In addition, the photometric waveform extraction control unit 402 includes a counter 403 and a correction time storage memory 404. The data processing unit 307 can be configured with a processor that executes a program. In this case, the processor operates as a functional unit for executing a predetermined function by executing a predetermined program.

Here, M reaction cells 112 are mounted on the reaction disk 104, and a number (cell number) for uniquely specifying a mounting position is set for each of mounting positions of the reaction cells 112. To the counter 403, the number (total cell number) M of the reaction cells mounted on the reaction disk 104, and a cell number (initial value cell number) and the photometry trigger signal T of the reaction cell 112 initially crossing the optical axis 205 of the light source 120 when the reaction disk 104 starts to rotate are input from the processor 303. The counter 403 outputs, as the cell number, a value obtained by adding 1 to the initial value cell number whenever the photometry trigger signal T is input. When the cell number reaches the total cell number M, the cell number is reset to 1 at a timing at which the next photometry trigger signal T is input. The correction time storage memory 404 stores the correction time t_{cal}_st for each of the reaction cells 112 specified by the cell numbers.

When a photometric waveform i corresponding to a reaction cell with a cell number i is input to the photometric waveform extraction unit 401, the correction time t_{cal}_st and the photometric value calculation period t_{cal} of the cell number i are input from the photometric waveform extraction control unit 402 to the photometric waveform extraction unit 401. Using these information, the photometric waveform extraction unit 401 extracts the photometric waveform of the photometric value calculation period t_{cal} of the reaction cell with the cell number i.

Modification Example of Second Example of Calculating Correction Time t_{cal}_st

When the correction time t_{cal}_st is set for each of the reaction cells 112 on the reaction disk 104, the correction time t_{cal}_st and the photometric value calculation period t_{cal} can be set according to the waveform of the photometry available period t of the photometric waveform of the reaction cell 112.

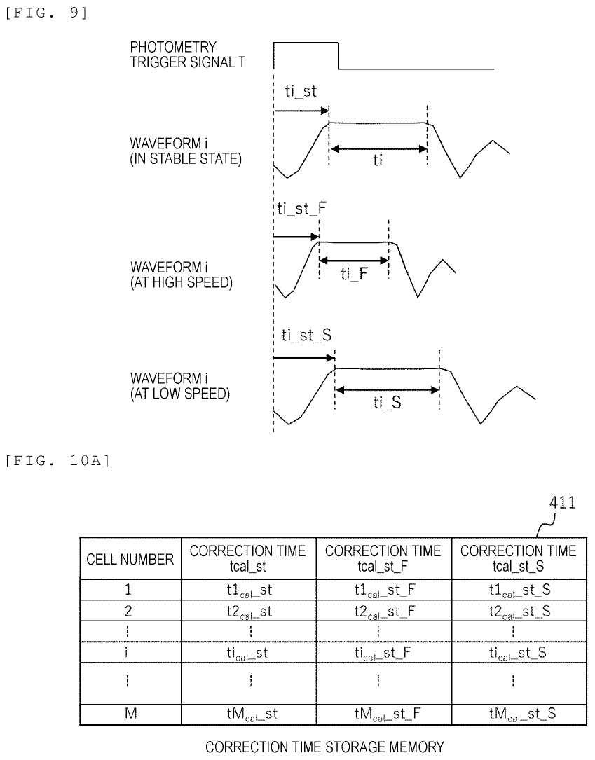

In the case of a waveform X illustrated in FIG. 8, in the waveform of the photometry available period t, the latter half is substantially 0, whereas the first half is gentle but has a slope. Likewise, in the case of a waveform Y illustrated in FIG. 8, in the waveform of the photometry available period t, the first half is substantially 0, whereas the latter half is gentle but has a slope. In this case, it is desirable to set the correction time such that the waveform where the slope in the waveform of the photometry available period t is substantially 0 can be extracted.

In this case, the case of the waveform X, the correction time is set such that the photometric value calculation period is set in the latter half of the waveform of the photometry available period t, and in the case of the waveform Y, the correction time is set such that the photometric value calculation period is set in the first half of the waveform of the photometry available period t.

Third Example of Calculating Correction Time t_{cal}_st

In the third example, the correction time t_{cal}_st and the photometric value calculation period t_{cal} can be set according to a rotational speed of the reaction disk 104. Here, as in the second example, an example of setting the correction time t_{cal}_st and the photometric value calculation period t_{cal} for each of the reaction cells 112 on the reaction disk 104 will be described.

The reaction disk 104 executes the rotation operation at a certain speed. When the rotation starts and when the rotation is stopped, the reaction disk 104 moves at a higher speed than the certain speed and moves at a lower speed than the certain speed, respectively. Therefore, a photometric waveform of the reaction cell 112 crossing the optical axis 205 immediately after the start of the rotation operation of the reaction disk 104 and a photometric waveform of the reaction cell 112 crossing the optical axis 205 immediately before the stop of the rotation operation of the reaction disk 104 are different from a photometric waveform of the reaction cell 112 crossing the optical axis 205 when the reaction disk 104 rotates at the certain speed. FIG. 9 illustrates this state. As compared to the waveform in the stable state, each of the photometry start available time t_st and the photometry available period t decreases at the high speed, and increases at the low speed.

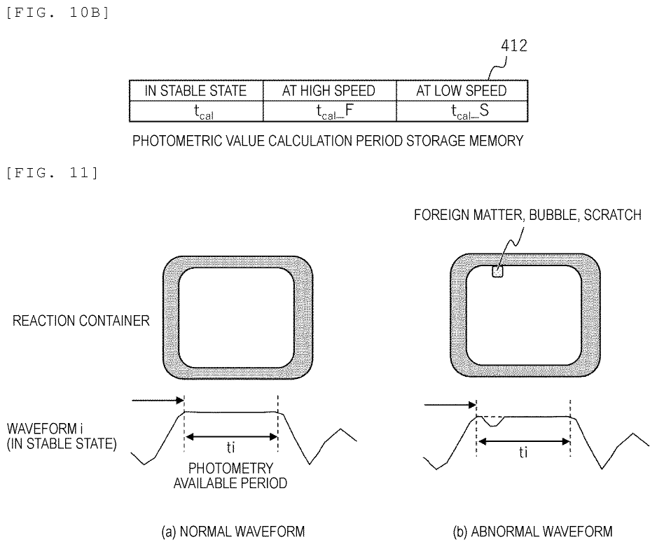

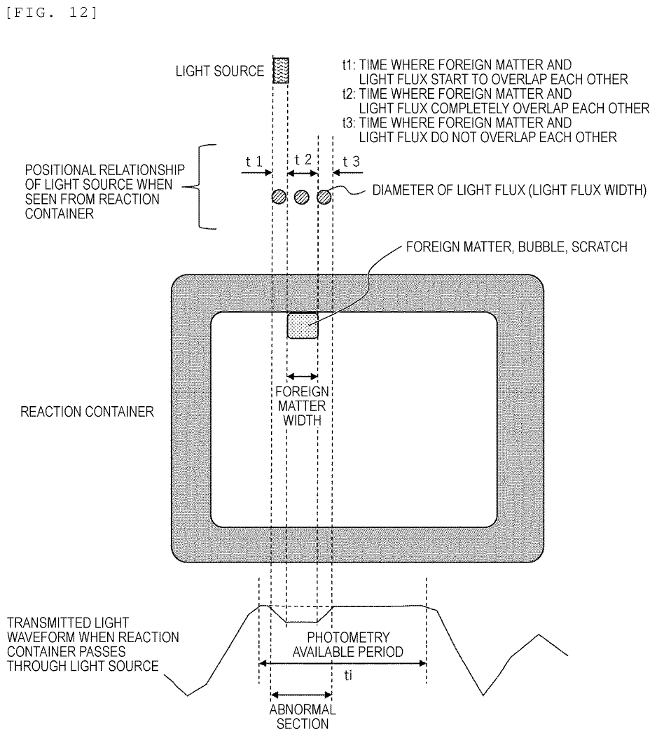

Accordingly, in the third example, the photometry start available time t_st and the photometry available period t are adjusted according to the rotational speed of the reaction disk 104. Therefore, the photometric waveform extraction control unit 402 includes a correction time storage memory 411 illustrated in FIG. 10A and a photometric value calculation period storage memory 412 illustrated in FIG. 10B. As a result, when the photometric waveform where the extraction process is executed is the photometric waveform where the reaction disk 104 executes the high-speed operation immediately after the rotation start, the extraction process is executed using a correction time at the high speed (correction time t_{cal}_st_F) and a photometric value calculation period at the high speed (photometric value calculation period t_{cal}_F), and when the photometric waveform where the extraction process is executed is the photometric waveform where the reaction disk 104 executes the low-speed operation immediately before the rotation stop, the extraction process is executed using a correction time at the low speed (correction time t_{cal}_st_S) and a photometric value calculation period at the low speed (photometric value calculation period t_{cal}_S). Whether the rotational speed of the reaction disk 104 is the speed in the stable state, the low speed, or the high speed can be determined depending on the cell number.

Here, the example of setting the correction time t_{cal}_st and the photometric value calculation period t_{cal} for each of the reaction cells 112 has been described. However, even when the correction time t_{cal}_st common to the reaction disk 104 is set, the correction time t_{cal}_st and the photometric value calculation period t_{cal} can be set using the same method.

The present invention is not limited to the embodiments described above and includes various modification examples. For example, the embodiments and the modification example have been described in detail in order to easily describe the present invention, £ and the present invention is not necessarily to include all the configurations described above. In addition, a part of the configuration of one embodiment or modification example can be replaced with the configuration of another embodiment or modification example. Further the configuration of one embodiment or modification example can be added to the configuration of another embodiment or modification example. In addition, addition, deletion, and replacement of another configuration can be made for a part of the configuration of each of the embodiment and modification examples.

### Second Embodiment

The first embodiment is characterized in that the photometry start available time, the photometry available period, and the like are determined based on the photometric waveform. However, in a second embodiment, an example where the photometric waveform is applied to a case other than the determination of the photometry start available time, the photometry available period, and the like will be described.
(a) of FIG. 11 illustrates a photometric waveform in a state where the reaction container is filled with a uniform liquid. It can be seen that a photometry output that is symmetrical with respect to the central axis of the reaction container is obtained. On the other hand, (b) illustrates a photometric waveform when foreign matter such as a bubble or a scratch is present in the reaction container. It can be seen that, since light from the light source is scattered by the foreign matter, the photometric intensity decreases in the vicinity of the foreign matter. Using this phenomenon, it can be detected that the foreign matter is present in the reaction container.

In addition, although not illustrated in the drawing, the way of light scattering varies between a scratch and a bubble. Therefore, by skipping (cell skipping) a reaction container (reaction cell) for which it is determined that a scratch is present to prevent this reaction container from being used in the subsequent analysis, the reliability of the measurement result can be improved. Alternatively, by notifying a device operator that there is a reaction container that needs to be replaced, the replacement of the reaction container is urged, and highly reliable analysis can be executed.

In addition, when it is determined that the liquid (reaction liquid) in the reaction container contains many bubbles, assuming that the viscosity of a specimen to be analyzed is high such that bubbles are likely to be formed or that there is possibility that a normal analysis result cannot be obtained due to a problem in the reagent such as deterioration of the reagent, it is effective to allocate an alarm representing the problem to the analysis result, or to leave a comment to urge the device operator for re-analysis. In order to make the above-described determination, it is preferable that reference data for identifying a reaction container where a scratch or a bubble is present is generated and stored based on a photometric waveform measured using a reaction container that is artificially scratched or a reaction container where a bubble is caused to be formed, and the reference data and an actual photometric waveform are compared to determine whether or not a scratch or a bubble is present.

In the determination, a threshold may be provided in the photometric waveform such that, when the photometric waveform falls by the threshold or more, it is determined that a scratch or a bubble is present. In order to further increase the determination accuracy, a well-known statistical method such as the Mahalanobis distance can also be used. That is, for example, the Mahalanobis distance is obtained based on a normal photometric waveform to obtain a threshold of a normal space, and when the photometric waveform exceeds the threshold, it is determined that an abnormality occurs.

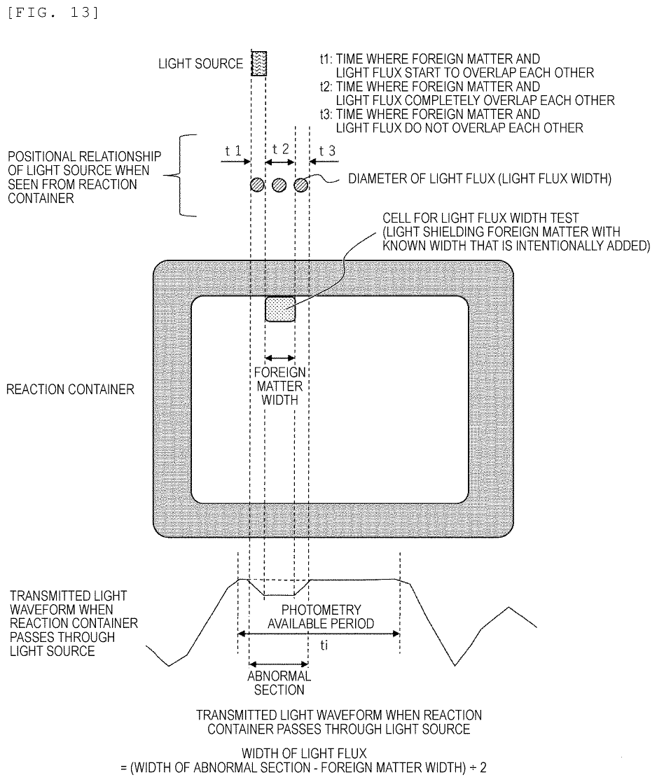

FIG. 12 illustrates an embodiment where the size of foreign matter is estimated based on the diameter of a light flux of light from the light source.

In FIG. 12, a time where the foreign matter and the light flux starts to overlap each other is represented by t1, a time where the foreign matter and the light flux completely overlap each other is represented by t2, and a time where the foreign matter and the light flux do not overlap each other is represented by t3.

An abnormal section where the photometric waveform is abnormal=the width of the foreign matter+(the width of the light flux×2). Therefore, based on this expression, the width (size) of the foreign matter can be obtained.

As a result, for example, when the measured foreign matter is a scratch and the size thereof is a predetermined value or more, by notifying the device operator that the replacement of the reaction container is necessary, the use of the reaction container for the specimen measurement and analysis that cannot be used for result report can be avoided. In addition, when the size of the bubble is a predetermined value or more, by notifying the device operator that analysis using the specimen or reagent is to be stopped, the specimen or reagent can be prevented from being unnecessarily used.

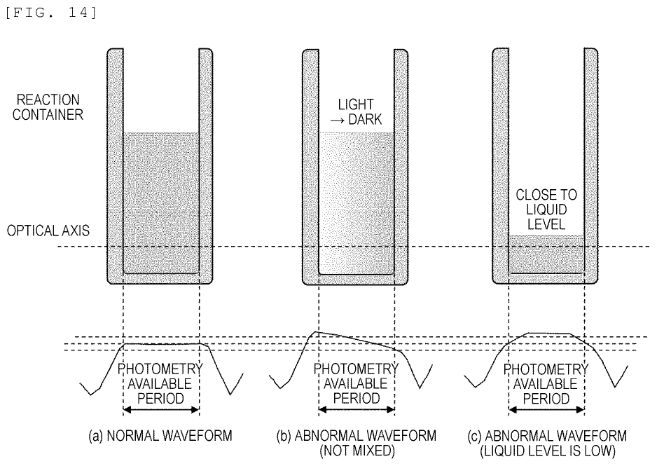

FIG. 13 illustrates an example where the diameter of a light flux can be obtained by adding foreign matter with a known size (object that can shield the light flux) to the reaction container contrary to FIG. 12. Light from the light source is designed such that an optical path is bent by a reflecting mirror, a slit the like is provided to obtain a predetermined light flux width, and the light transmits through the reaction container.

When an abnormality occurs in this optical system due to some reason, the width of the light flux may change. However, the automatic analyzer only measures a change in absorbance to automatically analyze the reaction based on this change. Therefore, even when the width of the light flux changes, the occurrence of the abnormality cannot be detected. That is, there is a possibility that an erroneous analysis result may be reported. By regularly observing (inspecting) the diameter of the light flux, the occurrence of abnormality in the optical system can be detected.

In addition, recently, an automatic analyzer where a light-emitting diode (LED) is used as a light source instead of a halogen lamp in the related art has appeared. The light-emitting diode produces white light. Therefore, an optical system where white light produced by emitting light of an LED that emits blue light to a fluorescent substance is combined with light from a light-emitting diode that emits ultraviolet light to synthesize irradiation light may be used. When a light source including this complex optical system is used, the possibility that the direction of the LED changes to change the direction of the irradiation light is not zero. Even in this case, by regularly monitoring the diameter of the light flux, the occurrence of an abnormality in the light source can be detected.

When the width of the light flux exceeds a predetermined threshold, the occurrence of an abnormality may be notified. A change over time in the measured width of the light flux may also be recorded in advance such that a period of time required to exceed a predetermined threshold assuming that the automatic analyzer is used as it is can be predicted based on the change over time and can be notified.

FIG. 13 illustrates the example where the light shielding foreign matter with a known width is provided on an inner surface of the reaction container. However, the thickness of the container wall of the reaction container can also be considered the light shielding foreign matter with a known width. The thickness of the container wall of the reaction container slightly varies between the reaction containers. Therefore, one or a plurality of reaction containers are set as reaction containers for checking the diameter of the light flux, and the change over time in the diameter of the light flux is measured based on the shape of the transmitted light waveform depending on the thickness of the container wall.

In the method where the container wall is considered foreign matter, the length of the container wall (the length in the vertical direction in FIG. 13) is long. Therefore, the attenuation amount of the transmitted light is large, and there is a possibility that the detection sensitivity is lower as compared to the method where the foreign matter with a known width is provided. However, there is an advantageous effect in that the reaction container where foreign matter is provided does not need to be separately prepared.

As another method, a method in which a clearance between one reaction container and another reaction container is considered foreign matter can also be used. In some automatic analyzer, a reaction container where a plurality of reaction containers are formed as one block is present. In the case of the block-shaped reaction container, the distance of the clearance between adjacent reaction containers is constant. Therefore, the clearance can be considered foreign matter. As compared to the case where the container wall is considered foreign matter, the light intensity is higher. Therefore, the diameter of the light flux can be measured with higher accuracy.

FIG. 14 illustrates an example where the state of the liquid in the reaction container is detected based on the photometric waveform. The measurement result is calculated based on a change in absorbance that is measured using a photometer in a state where the specimen and the reagent in the reaction container are mixed and stirred to cause the reaction to sufficiently occur. However, even in this case, the possibility that the measurement is executed in a state where stirring is not sufficient due to occurrence of some malfunction in the stirring mechanism is not zero.

The stirring mechanism has various abnormality detection functions to detect an abnormality of the stirring mechanism. However, there may be a case where occurrence of an abnormality that is lower than or equal to the abnormality detection sensitivity cannot be detected. Even in this case, in the present embodiment, a stirring abnormality can be detected based on the output of the photometer.
(a) of FIG. 14 illustrates a photometric waveform where a normal reaction liquid is used. The photometric waveform is symmetrical with respect to the central axis of the reaction container. On the other hand, when the concentration of the reaction liquid is low on the left side of the reaction container (that is, bright because light is likely to transmit through the reaction container) and is high on the right side (that is, dark because light is not likely to transmit through the reaction container) due to some reason such as insufficient stirring, an asymmetrical photometric waveform where the light intensity is high on the left side and is low on the right side is obtained. This way, the mixing condition Of the reaction liquid in the reaction container can be determined based on the symmetry of the photometric waveform.

As the determination method, various methods such as a method of determining that a mixing failure occurs when a difference between left and right peak values of the photometric waveform exceeds a predetermined threshold or a determination method based on the slope of the photometric waveform (in (b) Of FIG. 14, the detection height of the photometer monotonously decreases from the left side to the right side) can be used.

In addition, the optical axis is set such that the light flux from the light source passes through a possible lowest position of the reaction container where at least the measurement of the reaction liquid in the reaction container can be executed. However, when the amount of the reaction liquid in the reaction container decreases as the position of the optical axis, there may be a case where an appropriate measurement result cannot be obtained. (c) of FIG. 14 illustrates a photometric waveform where the liquid level of the reaction liquid is close to the optical axis. It can be seen that the photometric waveform is not smooth and has an upwardly convex shape. This way, even when the photometric waveform is symmetrical but has a slope in the left-right direction, an alarm may be allocated to the analysis result assuming that there is a possibility that the liquid amount is small and an appropriate measurement result cannot be obtained.

In addition, the automatic recognizes the amount of the reaction liquid for each analysis item. Therefore, it can be seen based on the actually measured photometric waveform that, when it is detected that the amount of the reaction liquid is small with respect to the set amount of reaction liquid, there is a possibility that any abnormality occurs in an aliquoting probe of a specimen or reagent. That is, an abnormality in the aliquoting probe can be detected by determining whether or not the actual liquid amount is insufficient with respect to the liquid amount stored in the automatic analyzer based on the photometric waveform.

### Reference Signs List

100: automatic analyzer
101: transport line
102: rotor
103: reagent disk
104: reaction disk
105: aliquoting mechanism
106: stirring mechanism
107: spectroscopic analyzer
108: reaction cell cleaning mechanism
109: nozzle cleaning mechanism
110: specimen container
111: specimen rack
112: reaction cell
113: reagent container
114: shield portion
115: control unit
117: liquid level sensor
118: arm
119: motor for aliquoting mechanism
120: light source
121: specimen aliquoting position
122: reagent aliquoting position
123: input unit
124: display unit
200: position detection unit
201: detection plate
202: detection plate detector
203: light emitting unit
204: photodetection unit
205: optical axis
301: spectrometer
302: photodetector
303: processor
304: photometry unit
305: current-voltage conversion unit
306: A/D conversion unit
307: data processing unit
401: photometric waveform extraction unit
402: photometric waveform extraction control unit
403: counter
404, 411: correction time storage memory
412: photometric value calculation period storage memory

1-24. (canceled)

25. An automatic analyzer comprising:
a reaction disk where a plurality of reaction cells are held on a circumference and configured to execute a rotation operation;
a light source configured to emit light;
a spectroscopic analyzer configured to detect transmitted light that transmits through a reaction cell crossing an optical axis of the light source when the reaction disk executes the rotation operation; and
a control unit including a photometry unit configured to extract, from a photometric waveform, a photometric waveform of a photometric value calculation period used for calculating a light intensity value regarding a liquid accommodated in the reaction cell, the photometric waveform being obtained by sampling a photometry signal that reflects a light intensity value of the transmitted light output from the spectroscopic analyzer,
wherein the control unit acquires a photometric waveform for each of the plurality of reaction cells held on the reaction disk from a photometry signal based on a photometry trigger signal, and sets the individual photometric value calculation period for each of the plurality of reaction cells based on a time domain representing a flat waveform, the photometry signal being obtained by executing photometry of the plurality of reaction cells in an empty state or in a state where blank water is accommodated, the photometry trigger signal representing that each of the plurality of reaction cells crosses the optical axis of the light source, and the time domain being obtained regarding the photometric waveform for each of the plurality of reaction cells.

26. The automatic analyzer according to claim 25,
wherein regarding the photometric waveform for each of the plurality of reaction cells, the control unit obtains a photometry available period that is a time period where the waveform is flat and a photometry start available time from rising of the photometry trigger signal to start of the photometry available period, and sets a correction time where the photometric value calculation period starts from the rising of the photometry trigger signal based on the photometry available period and the photometry start available time obtained regarding the photometric waveform for each of the plurality of reaction cells.

27. The automatic analyzer according to claim 25, further comprising a position detection unit configured to output the photometry trigger signal,
wherein the position detection unit includes a plurality of detection plates provided corresponding to the plurality of reaction cells held on the reaction disk, respectively, and a detection plate detector configured to detect passage of the detection plate, and
the detection plate detector is provided at a position where the detection plate passes when a reaction cell corresponding to the detection plate crosses the optical axis of the light source.

28. The automatic analyzer according to claim 25,
wherein the control unit sets the photometric value calculation period according to a slope of the photometric waveform in the time domain.

29. An automatic analyzer comprising:
a reaction disk where a plurality of reaction cells are held on a circumference and configured to execute a rotation operation;
a light source configured to emit light;
a spectroscopic analyzer configured to detect transmitted light that transmits through a reaction cell crossing an optical axis of the light source when the reaction disk executes the rotation operation; and
a control unit including a photometry unit configured to extract, from a photometric waveform, a photometric waveform of a photometric value calculation period used for calculating a light intensity value regarding a liquid accommodated in the reaction cell, the photometric waveform being obtained by sampling a photometry signal that reflects a light intensity value of the transmitted light output from the spectroscopic analyzer,
wherein the control unit acquires a photometric waveform for each of the plurality of reaction cells held on the reaction disk from a photometry signal based on a photometry trigger signal, and sets the photometric value calculation period common to the plurality of reaction cells according to a rotational speed of the reaction disk based on a time domain representing a flat waveform, the photometry signal being obtained by executing photometry of the plurality of reaction cells in an empty state or in a state where blank water is accommodated, the photometry trigger signal representing that each of the plurality of reaction cells crosses the optical axis of the light source, and the time domain being obtained regarding the photometric waveform for each of the plurality of reaction cells.

30. The automatic analyzer according to claim 25,
wherein the control unit detects occurrence of an abnormality based on a local change of the photometry signal of the waveform in the time domain representing a flat waveform obtained regarding the photometric waveform for each of the plurality of reaction cells.

31. The automatic analyzer according to claim 30,
wherein when the occurrence of the abnormality is detected, the control unit notifies the occurrence of the abnormality.

32. The automatic analyzer according to claim 30
wherein the control unit detects a size of an abnormality occurrence position based on the local change of the photometry signal of the waveform.

33. The automatic analyzer according to claim 30,
wherein the control unit stores the flat waveform obtained regarding the photometric waveform for each of the plurality of reaction cells as measurement results at at least two different time points in chronological order, and compares the flat waveforms of the photometric waveforms at the different time points to specify a position where the abnormality of the reaction cell occurs.

34. The automatic analyzer according to claim 30,
wherein the control unit stores the flat waveform obtained regarding the photometric waveform for each of the plurality of reaction cells as measurement results at at least two different time points in chronological order, compares the flat waveforms of the photometric waveforms at the different time points to identify a degree of the abnormality of the reaction cell, and determines a replacement period of the reaction cell based on the identification result.

35. The automatic analyzer according to claim 25,
wherein the control unit detects a light flux diameter of the transmitted light that transmits through the reaction cell based on a photometric waveform regarding a position having a known size in the reaction cell.

36. The automatic analyzer according to claim 35,
wherein the control unit stores the detected light flux diameter as measurement results at at least two different time points in chronological order, and compares the light flux diameters at the different time points to detect an abnormality of an optical system of the transmitted light.

37. The automatic analyzer according to claim 36,
wherein when the abnormality of the optical system of the transmitted light is detected, the control unit notifies the detection.

38. The automatic analyzer according to claim 35,
wherein the control unit stores the detected light flux diameter as measurement results at at least two different time points in chronological order, and predicts a maintenance period based on a change between the light flux diameters at the different time points.

39. The automatic analyzer according to claim 25,
wherein when the photometry signal of the waveform substantially monotonously decreases or increases in the time domain representing a flat waveform obtained regarding the photometric waveform for each of the plurality of reaction cells, the control unit detects that a stirring failure of a reaction liquid in the reaction cell occurs.

40. The automatic analyzer according to claim 25,
wherein when the photometry signal of the waveform in the time domain representing a flat waveform obtained regarding the photometric waveform for each of the plurality of reaction cells changes substantially in an upwardly convex shape, the control unit detects that the measurement is executed in a state where a reaction liquid in the reaction cell is insufficient.

41. A timing setting method in an automatic analyzer including a reaction disk where a plurality of reaction cells are held on a circumference and configured to execute a rotation operation, a light source configured to emit light, a spectroscopic analyzer configured to detect transmitted light that transmits through a reaction cell crossing an optical axis of the light source when the reaction disk executes the rotation operation, and a control unit including a photometry unit configured to extract, from a photometric waveform, a photometric waveform of a photometric value calculation period used for calculating a light intensity value regarding a liquid accommodated in the reaction cell, the photometric waveform being obtained by sampling a photometry signal that reflects a light intensity value of the transmitted light output from the spectroscopic analyzer,
the timing setting method comprising allowing the control unit:
to acquire a photometric waveform for each of the plurality of reaction cells held on the reaction disk from a photometry signal based on a photometry trigger signal, the photometry signal being obtained by executing photometry of the plurality of reaction cells in an empty state or in a state where blank water is accommodated, the photometry trigger signal representing that each of the plurality of reaction cells crosses the optical axis of the light source, and
to set the individual photometric value calculation period for each of the plurality of reaction cells based on a time domain representing a flat waveform obtained regarding the photometric waveform for each of the plurality of reaction cells.

42. The timing setting method according to claim 41, comprising allowing the control unit:
to obtain, regarding the photometric waveform for each of the plurality of reaction cells, a photometry available period that is a time period where the waveform is flat and a photometry start available time from rising of the photometry trigger signal to start of the photometry available period, and
to set a correction time where the photometric value calculation period starts from the rising of the photometry trigger signal based on the photometry available period and the photometry start available time obtained regarding the photometric waveform for each of the plurality of reaction cells.

43. The timing setting method according to claim 41, comprising allowing the control unit to set the photometric value calculation period according to a slope of the photometric waveform in the time domain.

44. A timing setting method in an automatic analyzer including a reaction disk where a plurality of reaction cells are held on a circumference and configured to execute a rotation operation, a light source configured to emit light, a spectroscopic analyzer configured to detect transmitted light that transmits through a reaction cell crossing an optical axis of the light source when the reaction disk executes the rotation operation, and a control unit including a photometry unit configured to extract, from a photometric waveform, a photometric waveform of a photometric value calculation period used for calculating a light intensity value regarding a liquid accommodated in the reaction cell, the photometric waveform being obtained by sampling a photometry signal that reflects a light intensity value of the transmitted light output from the spectroscopic analyzer,
the timing setting method comprising allowing the control unit:
to acquire a photometric waveform for each of the plurality of reaction cells held on the reaction disk from a photometry signal based on a photometry trigger signal, the photometry signal being obtained by executing photometry of the plurality of reaction cells in an empty state or in a state where blank water is accommodated, the photometry trigger signal representing that each of the plurality of reaction cells crosses the optical axis of the light source, and
to set the photometric value calculation period common to the plurality of reaction cells according to a rotational speed of the reaction disk based on a time domain representing a flat waveform obtained regarding the photometric waveform for each of the plurality of reaction cells.

45. An automatic analyzer comprising:
a reaction disk where a plurality of reaction cells are held on a circumference and configured to execute a rotation operation;
a light source configured to emit light;
a spectroscopic analyzer configured to detect transmitted light that transmits through a reaction cell crossing an optical axis of the light source when the reaction disk executes the rotation operation; and
a control unit including a photometry unit configured to extract, from a photometric waveform, a photometric waveform of a photometric value calculation period used for calculating a light intensity value regarding a liquid accommodated in the reaction cell, the photometric waveform being obtained by sampling a photometry signal that reflects a light intensity value of the transmitted light output from the spectroscopic analyzer,
wherein the control unit
acquires a photometric waveform for each of the plurality of reaction cells held on the reaction disk from a photometry signal based on a photometry trigger signal, the photometry signal being obtained by executing photometry of the plurality of reaction cells in an empty state or in a state where blank water is accommodated, the photometry trigger signal representing that each of the plurality of reaction cells crosses the optical axis of the light source,
obtains, regarding the photometric waveform acquired for the plurality of reaction cells, a photometry available period that is a time period where the waveform is flat and a photometry start available time from rising of the photometry trigger signal to start of the photometry available period,
sets a correction time that is a photometry start available time common to the plurality of reaction cells as a value more than a maximum value of the photometry start available time obtained for each of the plurality of reaction cells, and
sets the photometric value calculation period based on the set correction time.

46. The automatic analyzer according to claim 45,
wherein the control unit sets the photometric value calculation period common to the plurality of reaction cells based on the correction time.

47. The automatic analyzer according to claim 25,
wherein the control unit sets the individual photometric value calculation period for each of the plurality of reaction cells according to a rotational speed of the reaction disk.

48. The timing setting method according to claim 41, comprising allowing the control unit to set the individual photometric value calculation period for each of the plurality of reaction cells according to a rotational speed of the reaction disk.
